(19) United States
(12) Patent Application Publication
(10) Pub. No.: US 2025/0133591 A1
(43) Pub. Date: Apr. 24, 2025

(54) MULTI-LINK COMMUNICATION METHOD AND COMMUNICATION APPARATUS

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/682,719

(22) PCT Filed: Aug. 16, 2021
(86) PCT No.: PCT/CN2021/112842

§ 371 Date: Feb. 9, 2024

(51) Int. Cl. H04W 74/0816; H04W 48/16; H04W 74/08

(52) U.S. Cl. CPC H04W 74/0816; H04W 48/16; H04W 74/0866

(57) ABSTRACT

A communication method may include, before a station device performs tunneled direct link setup (TDLS) communication, performing listening under each of a plurality of links, wherein the communication of the station device can only be performed under one link at the same time, and if a listening result indicates that an access point device is executing data transmission, then delaying the TDLS communication. The access point device supports multi-link communication, and the station device is associated with the access point device.

### CROSS REFERENCE

The present application is a national phase application of International Application No. PCT/CN2021/112842, filed on Aug. 16, 2021, and the entire contents thereof are incorporated herein by reference.

### BACKGROUND

### Technical Field

The present disclosure relates to the field of wireless communications, and more specifically, to a multi-link communication method and communication device.

### Description of the Related Art

The current research scope of Wi-Fi technology is: 320 MHz bandwidth transmission, aggregation and coordination of multiple frequency bands, etc. It is expected to increase the rate and throughput by at least four times compared to existing standards. Its main application scenarios are video transmission, AR (Augmented Reality), VR (Virtual Reality), etc.

The aggregation and collaboration of multiple frequency bands is that the device communicates simultaneously in frequency bands such as 2.4 GHz, 5 GHz, and 6 GHz. For the device to communicate in multiple frequency bands at the same time, a new MAC (Media Access Control) mechanism for management needs to be defined. In addition, it is also expected that the aggregation and coordination of multiple frequency bands can support low-latency transmission.

The current multi-band aggregation and system technology will support a maximum bandwidth of 320 MHz (160 MHz+160 MHz), and may also support 240 MHz (160 MHz+80 MHz) and other bandwidths.

In current technology, stations (STA) and access points (AP) can be the multi-link devices (MLD), that is, they support the functionality of sending and/or receiving on multiple connections. Therefore, in the current technology, multiple connections can exist between STA and AP, and the communication of these two devices on multiple connections is being studied.

It should be noted that, information disclosed in the above background portion is provided only for better understanding of the background of the present disclosure, and thus it may contain information that does not form the prior art known by those ordinary skilled in the art.

### SUMMARY

Various embodiments of the present disclosure provide the following technical solutions:

Example embodiments according to the present disclosure provide a communication method on multiple connections. The communication method may be performed by a station device supporting multi-link communication (non-AP STA MLD), and includes: before the station device performs tunneled direct link setup (TDLS) communication, performing listening on each of multiple connections, wherein the communication of the station device can only be carried out on one connection at the same time; if the result of the listening indicates that the access point device is performing data transmission, the TDLS communication is delayed, wherein the access point device supports multi-link communication, and the station device is associated with the access point device.

Example embodiments according to the present disclosure provide a communication method on multiple connections. The communication method may be performed by an access point device supporting multi-link communication (AP MLD), and includes: receiving a first message frame from a station device supporting multi-link communication on a first connection among a plurality of connections, wherein, the first message frame includes information indicating that TDLS data transmission is requested by the station device, the access point device is associated with the station device, wherein the communication of the station device can only be carried out on one connection at the same time; and in response to receiving the first message frame, sending a second message frame to the station device, wherein the second message frame indicates that the station device is allowed to send the TDLS data on the first connection.

Example embodiments according to the present disclosure provide a communication device. The communication device may support multi-link communication and include a processing module. The processing module is configured to: before the communication device performs tunneled direct link setup (TDLS) communication, perform listening on each of multiple connections, wherein the communication of the communication device can only be carried out on one connection at the same time; if the result of the listening indicates that the access point device is performing data transmission, the TDLS communication is delayed, wherein the access point device supports multi-link communication, and the communication device is associated with the access point device.

Example embodiments according to the present disclosure provide a communication device. The communication device may support multi-link communication and include a transceiver module and a processing module. The transceiver module is configured to: receive a first message frame from a station device supporting multi-link communication on a first connection among a plurality of connections, wherein, the first message frame includes information that TDLS data transmission is requested by the station device, the communication device is associated with the station device, wherein the communication of the station device can only be carried out on one connection at the same time; and the processing module is configured to: in response to receiving the first message frame, control the transceiver module to send a second message frame to the station device, wherein the second message frame indicates that the station device is allowed to send the TDLS data on the first connection.

Example embodiments according to the present disclosure provide an electronic device. The electronic device includes a memory, a processor, and a computer program stored on the memory and executable on the processor. The processor implements the method as described above when executing the computer program.

Example embodiments according to the present disclosure provide a computer-readable storage medium. A computer program is stored on the computer-readable storage medium. The computer program, when executed by the processor, implements the method described above.

It is to be understood that both the foregoing general description and the following detailed description are exemplary and explanatory only and are not restrictive of the invention, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exemplary diagram illustrating a multi-link communication scenario according to an embodiment.

FIG. 2 is an exemplary diagram illustrating tunneled direct link setup (TDLS) according to an embodiment.

FIG. 3 is a flowchart illustrating a communication method according to an embodiment.

FIG. 4 is a detailed flowchart illustrating a communication method according to an embodiment of the present disclosure.

FIG. 5 is a flowchart illustrating a communication method according to an embodiment.

FIG. 6 is a block diagram illustrating a communication device according to an embodiment.

### DETAILED DESCRIPTION OF THE PREFERRED EMBODIMENTS

Referring now to the drawings, wherein like reference numerals designate identical or corresponding parts throughout the several views.

The following description with reference to the accompanying drawings is provided to assist in a comprehensive understanding of various embodiments of the present disclosure as defined by the appended claims and their equivalents. Various embodiments of the present disclosure include various specific details, but these specific details are considered to be exemplary only. Additionally, descriptions of well-known techniques, functions, and constructions may be omitted for the sake of clarity and conciseness.

The terms and words used in this disclosure are not limited to the literal meanings, but, are merely used by the inventor to enable a clear and consistent understanding of the disclosure. Accordingly, to those skilled in the art, the description of the various embodiments of the present disclosure is provided for illustration purpose only and not for purpose of limitation.

It will be understood that, as used herein, the singular forms “a” “an” “said” and “the” may include the plural forms as well, unless the context clearly dictates otherwise. It should be further understood that the word “comprising” as used in this disclosure refers to the presence of the described features, integers, steps, operations, elements and/or components but does not exclude the presence or addition of one or more other features, integers, steps, operations, elements, components and/or groups thereof.

It will be understood that, although the terms “first,” “second,” etc. may be used herein to describe various elements, these elements should not be limited by these terms. These terms are only used to distinguish one element from another. Accordingly, a first element discussed below may be termed a second element without departing from the teachings of example embodiments.

It will be understood that when an element is referred to as being “connected” or “coupled” to another element, it can be directly connected or coupled to the other element or intervening elements may also be present. Additionally, “connected” or “coupled” as used herein may include wireless connections or wireless couplings. As used herein, the term “and/or” or the expression “at least one/at least one of” includes any and all combinations of one or more of the associated listed items.

Unless otherwise defined, all terms (including technical and scientific terms) used herein have the same meaning as commonly understood by one of ordinary skill in the art to which this disclosure belongs.

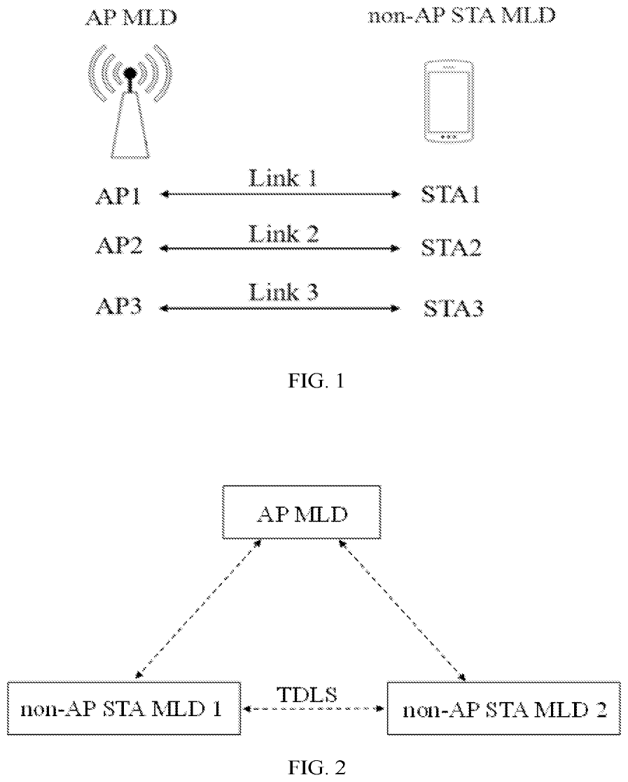

FIG. 1 is an exemplary diagram illustrating a multi-link communication scenario according to an embodiment.

In a wireless LAN, a basic service set (BSS) may include of an AP and one or more stations (STA) that communicate with the AP. A basic service set can be connected to the distribution system (DS) through its AP, and then connected to another basic service set to form an extended service set (ESS).

The AP is a wireless switch used in wireless networks and is also the access device of wireless networks. The AP device can be used as a wireless base station, mainly a bridge used to connect wireless networks and wired networks. Using this access point AP, wired and wireless networks can be integrated.

The AP may include software applications and/or circuitry to enable other types of nodes in the wireless network to communicate through the AP with both outside and within the wireless network. In some examples, as an example, the AP may be a terminal device or a network device equipped with a Wi-Fi (Wireless Fidelity) chip.

By way of example, a station (STA) may include, but is not limited to: a cellular phone, a smartphone, a wearable device, a computer, a personal digital assistant (PDA), a personal communications system (PCS) device, a personal information manager (PIM), a personal Navigation device (PND), a global positioning system, a multimedia device, an Internet of Things (IoT) device, etc.

In example embodiments of the present disclosure, the AP and STA may be devices that support multi-link communication, and may, for example, be represented as AP MLD and non-AP STA MLD respectively. For ease of description, hereinafter, an example in which one AP communicates with one STA on multiple connections is mainly described, however, example embodiments of the present disclosure are not limited thereto.

In FIG. 1, for example only, the AP MLD may represent an access point that supports the multi-link communication function, and the non-AP STA MLD may represent a station that supports the multi-link communication function. Referring to FIG. 1, the AP MLD can operate on three connections, as shown in FIG. 1, attached AP1, AP2 and AP3, and the non-AP STA MLD can also operate on three connections, as shown in FIG. 1, attached STA1, STA2 and STA3. In the example of FIG. 1, it is assumed that AP1 and STA1 communicate through the corresponding first connection Link 1. Similarly, AP2 and AP3 communicate with STA2 and STA3 through the second connection Link 2 and the third connection Link 3 respectively. In addition, Link 1 to Link 3 can be multiple connections at different frequencies, for example, connections at 2.4 GHz, 5 GHz, 6 GHz, etc., or connections at the same or different bandwidths of 2.4 GHz, 5 GHz, 6 GHz. Additionally, multiple channels can exist on each connection. However, it should be understood that the communication scenario shown in FIG. 1 is only exemplary, and the inventive concept is not limited thereto. For example, the AP MLD may be connected to multiple non-AP STA MLDs, or on each connection, the AP can communicate with multiple other types of stations.

Since the AP MLD participates in communication, the basic service set shown in FIG. 1 can be referred to as infrastructure basic service set (infrastructure BSS, which can be abbreviated as “infra-BSS” in this disclosure).

In order to improve transmission efficiency, the non-AP STA MLD can support tunneled direct link setup (TDLS) function. As shown in FIG. 2, an exemplary diagram of tunneled direct link setup (TDLS) is shown according to an embodiment.

Referring to FIG. 2, tunneled direct link setup (TDLS) may be implemented between a first multi-link station device non-AP STA MLD 1 and a second multi-link station device non-AP STA MLD 2. For example, communication (e.g., transmission of data) can occur directly between non-AP STA MLD 1 and non-AP STA MLD 2 without going through a multi-link access point device (AP MLD). For another example, non-AP STA MLD 1 can perform TDLS communication with non-AP STA MLD 2 via AP MLD.

One of the first multi-link station device non-AP STA MLD 1 and the second multi-link station device non-AP STA MLD 2 can serve as the initiator of TDLS to perform a TDLS discovery request, and the other can perform a TDLS discovery response as the responder of TDLS, and then a tunneled direct link is established between them through the TDLS setup process. For example, the TDLS establishment process may include: TDLS setup request, TDLS setup response, and TDLS setup confirm.

Referring to FIG. 2, an AP MLD may act as an intermediary to perform TDLS communications for information or data transfer between stations, or may perform communications with one or some non-AP STA MLDs (which may be referred to herein as “Basic Service Set Communications (infra-BSS Communications)”). Accordingly, the non-AP STA MLD can perform TDLS communication with another station directly (P2P), or perform TDLS communication with another station via the AP MLD; in addition, the non-AP STA MLD can also perform basic service set communication with the AP MLD.

However, non-AP STA MLD can operate in EMLSR (enhanced-multilink single radio) mode. The EMLSR mode is that the non-AP STA MLD can only communicate on one connection at a time. The non-AP STA MLD may notify the AP MLD through an EHT operating mode notification frame before starting the EMLSR (can only communicate on one connection at a time) mode. In addition, the non-AP STA MLD can also perform TDLS communication (through AP MLD, or P2P). When the non-AP STA MLD in EMLSR mode is also in TDLS communication, communication between EMLSR and TDLS needs to be planned.

On the other hand, non-AP STA MLD may support NSTR (non-simultaneous Tx & Rx) connections. For NSTR connections, only one of the sending operation or the receiving operation can be performed at the same time (if the sending time and arrival time are the same, sending and receiving on multiple connections can also be performed). Therefore, the above communication scenarios regarding EMLSR will also occur in NSTR connections. That is, in multi-link communication, planning for TDLS communication and basic service set communication (infra-BSS communication) is required for EMLSR mode or NSTR mode.

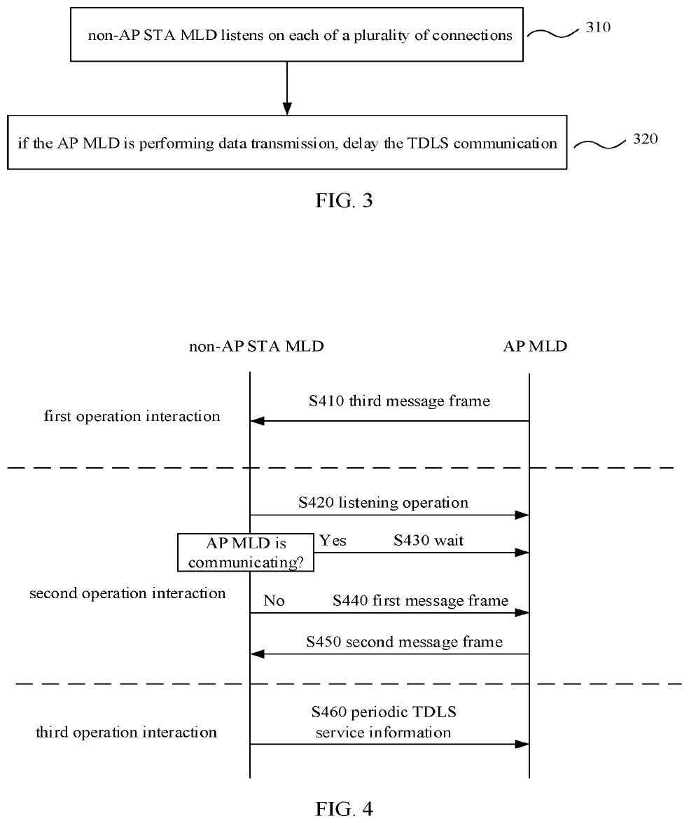

FIG. 3 is a flowchart illustrating a communication method on multiple connections according to an embodiment. The communication method shown in FIG. 3 can be applied to station devices that support multi-link communication, that is, non-AP STA MLD. According to embodiments of the present disclosure, a non-AP STA MLD may be associated with an AP MLD on multiple connections.

Referring to FIG. 3, in step 310, the non-AP STA MLD listens on each of a plurality of connections before conducting tunneled direct link setup (TDLS) communications, where the communication of the non-AP STA MLD can only be carried out on one connection at the same time.

According to an embodiment of the present disclosure, “the communication of the non-AP STA MLD can only be carried out on one connection at the same time” may mean that the non-AP STA MLD operates in the EMLSR mode, or the non-AP STA MLD operates in the NSTR connection. In this case, if the non-AP STA MLD wants to communicate with another station for TDLS, it needs to listen on multiple connections supported by the non-AP STA MLD. According to embodiments of the present disclosure, various methods such as carrier listening may be used to perform the listening. For example, but not limited to, the listening may be performed through energy detection (ED), carrier sensing (CS), and energy-carrier hybrid detection.

In step 320, if the result of the listening indicates that the AP MLD is performing data transmission, the TDLS communication is delayed.

According to an embodiment of the present disclosure, “AP MLD is performing data transmission” may refer to that the AP MLD is performing data transmission in a basic service set communication operation (i.e., infra-BSS communication), for example, AP MLD is performing data transmission to/from another station device. However, the present disclosure is not limited thereto, and “AP MLD is performing data transmission” may also refer to that AP MLD acts as an intermediary to perform TDLS data transmission between other two stations.

In the embodiment of the present disclosure, the duration for delaying the TDLS communication is determined based on the duration of the data transmission (data transmission of AP MLD) perceived during listening. That is, the TDLS communication is delayed until the data transmission of the AP MLD ends.

For example, non-AP STA MLD can communicate in two modes (EMLSR/NSTR mode and TDLS mode). In activated EMLSR mode/NSTR connection, such a non-AP MLD can listen on every connection before TDLS communication, if it senses that the AP MLD associated with it is communicating (e.g., data transmission), the TDLS communication is delayed, where the delay time is based on the sensed communication time.

In the communication method shown in FIG. 3, it can listen before executing TDLS communication, and delay the TDLS communication to be executed when it detects that the AP MLD is communicating, which can effectively avoid communication conflicts.

It will be understood that the communication method shown in FIG. 3 is exemplary and the present disclosure is not limited thereto. A detailed flowchart of a communication method according to an embodiment of the present disclosure will be described below with reference to FIG. 4.

Referring to FIG. 4, during the first operation interaction process, the non-AP STA MLD may receive a third message frame from the AP MLD (S410), where the third message frame may include the duration information of TDLS communication configured (planned) by the AP MLD. For example, the configured duration information of TDLS communication may include the duration of TDLS communication on each of the multiple connections of the AP MLD.

During the first operation, the AP MLD may, for example, pre-configure (plan) the duration of TDLS communication on each connection. For example, the third message frame may be a beacon frame, and the TDLS duration information configured by the AP MLD may be broadcasted by being carried in the quiet information element (quiet element) of the beacon frame. However, the present disclosure is not limited to this. The duration information of TDLS communication on each connection configured by the AP MLD may be carried in other frames, such as (re)association response frames or multi-link establishment response frames.

During the first operation interaction process, the non-AP STA MLD may receive the duration information of the TDLS communication configured by the APMLD from the APMLD to determine the time required to perform the TDLS communication on each connection, so as to determine the time required to perform the TDLS communication on each connection. Therefore, the configured TDLS communication duration information is referred to when performing TDLS communication, to avoid communication conflicts.

Continuing to refer to FIG. 4, in the second operation interaction process, operation S420 and operation S430 may correspond to step 310 and step 320 in FIG. 3 respectively. For the sake of simplicity, repeated descriptions are omitted here.

If the result of listening in operation S420 indicates that the AP MLD does not perform data transmission, or the affiliated station of the non-AP STA MLD successfully competes for the communication channel, or the delay period in operation S430 ends, operation S440 and operation S450 may be performed.

In operation S440, the non-AP STA MLD may send a first message frame to the AP MLD on a first connection among the plurality of connections. According to an embodiment of the present disclosure, the first message frame may include information indicating that the non-AP STA MLD requests TDLS data transmission.

For example, the non-AP STA MLD may send a first message frame to identify that it wants to perform TDLS communication (for example, send TDLS data) before sending the TDLS data. As a descriptive example only, the first message frame may be a MU-RTS (Multi-User Request To Send) frame through which the non-AP STA MLD may send a request for sending TDLS data to the AP MLD.

In operation S450, the non-AP STA MLD may receive a second message frame from the AP MLD. According to an embodiment of the present disclosure, the second message frame may indicate that the non-AP STA MLD is allowed to send TDLS data on the first connection. For example, the second message frame may be a CTS (clear to send)-to-self frame, and the CTS-to-self frame may indicate that sending on this connection is allowed. For example, in conjunction with FIG. 1, if the first connection used to send the first message frame (MU-RTS frame) in operation S440 is Link 2 in FIG. 1, then the second message frame (CTS-to-self frame) received in operation S450 can indicate that the non-AP STA MLD is allowed to send TDLS data on Link 2.

In addition, although not shown in FIG. 4, when the non-AP STA MLD receives the second message frame (CTS-to-self frame) from the AP MLD, the non-AP STA MLD can send TDLS data on the current connection through corresponding access point AP of the AP MLD.

Continuing to refer to FIG. 4, during the third operation interaction process, if there is a periodic TDLS service in the non-AP STA MLD, before performing the periodic TDLS service, it sends information about communication duration and/or cycle information of the periodic TDLS service to the AP MLD (S460). For example, the sent communication duration and/or cycle information about the periodic TDLS service may include: the communication duration and/or cycle of the periodic TDLS service on each of the multiple connections of the non-AP STA MLD.

The communication duration of the periodic TDLS service may refer to the duration required to send all periodic TDLS services, and the period of the periodic TDLS service may refer to the duration required to send a unit TDLS service. According to embodiments of the present disclosure, periodic TDLS services can be mapped to different connections. Therefore, the non-AP STA MLD can set the communication duration and cycle of the periodic TDLS services on multiple connections, and report them to AP MLD.

Although not shown in FIG. 4, the non-AP STA MLD may also receive response information from the AP MLD, and the response information may include whether the AP MLD agrees to the communication duration and period of the reported periodic TDLS service. For example, if the AP MLD agrees, it can feed back the corresponding acknowledgment frame; and if the AP MLD disagrees, it can feed back the recommended communication duration and cycle of the periodic TDLS service. In other words, the non-AP STA MLD can negotiate the communication duration and period of the periodic TDLS service with the AP MLD.

Although it is shown in FIG. 4 that the first operation interaction process, the second operation interaction process, and the third operation interaction process are executed sequentially, the embodiment of the present disclosure is not limited to that all three operation interaction processes must be executed, or must be executed in the order shown in FIG. 4.

For example, the first operation interaction process can be omitted, while the “non-AP STA MLD receiving the recommended TDLS communication duration information (the TDLS communication duration on each connection configured by the AP MLD) from the AP MLD” is added in the third operation interaction process. For another example, during the first operation interaction process, an operation of “non-AP STA MLD feeding back the recommended TDLS communication duration information to the AP MLD” can be added. For another example, in the second operation, operations S420 and S430 may be omitted, and whether to send the first message frame to the AP MLD is determined by determining whether channel competition is successful. For another example, the third operation interaction process may be performed before the second operation interaction process, that is, the non-AP STA MLD may first negotiate the duration information of TDLS communication with the associated AP MLD, and then start TDLS communication.

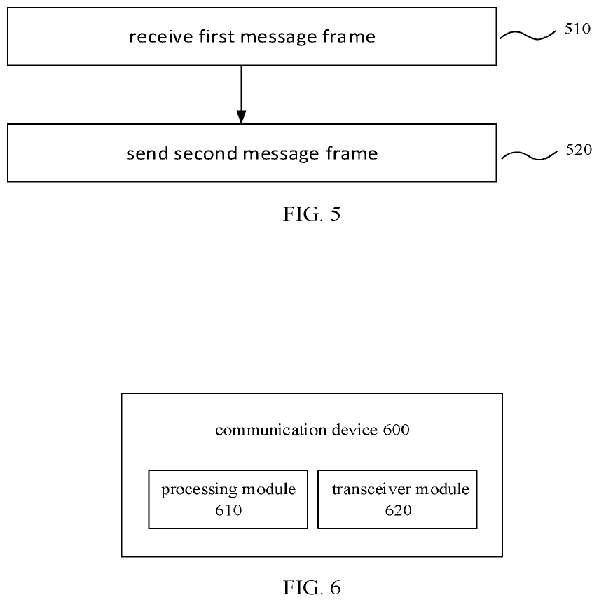

FIG. 5 is a flowchart illustrating a communication method according to an embodiment. The communication method shown in FIG. 5 can be applied to an access point device that supports multi-link communication, that is, an AP MLD. The AP MLD can associate with the non-AP STA MLD on multiple connections.

Referring to FIG. 5, in step 510, a first message frame may be received. Specifically, a first message frame is received from a station device (non-AP STA MLD) supporting multi-link communication on a first connection among the plurality of connections, wherein the first message frame may include information indicating that the non-AP STA MLD requests TDLS data transmission, wherein, the communication of the non-AP STA MLD can only be carried out on one connection at the same time.

Step 510 may correspond to operation S440 in FIG. 4, so the embodiment of operation S440 described with reference to FIG. 4 may be referenced here, and repeated descriptions are omitted for simplicity.

In step 520, in response to receiving the first message frame, sending a second message frame to the non-AP STA MLD, wherein the second message frame may indicate that the non-AP STA MLD is allowed to perform TDLS communication on the first connection (e.g., sending TDLS data).

Step 520 may correspond to operation S450 in FIG. 4, so the embodiment of operation S450 described with reference to FIG. 4 may be referenced here, and repeated descriptions are omitted for simplicity.

The communication method shown in FIG. 5 is only exemplary. For example, the AP MLD may also perform other operations performed by the AP MLD described with reference to FIG. 4.

According to an embodiment of the present disclosure, the communication method shown in FIG. 5 may further include: sending a third message frame, where the third message frame may include duration information of TDLS communication configured by the AP MLD. For example, the configured duration information of TDLS communication may include the duration of TDLS communication on each of the multiple connections of the AP MLD. The third message frame may be similar to the embodiment described with reference to operation S410 in FIG. 4, and repeated descriptions are omitted here to avoid redundancy.

According to an embodiment of the present disclosure, the communication method shown in FIG. 5 may further include: receiving information on the communication duration and/or cycle of the periodic TDLS service related to the periodic TDLS service of the non-AP STA MLD. For example, the information about the communication duration and/or cycle of the periodic TDLS service may include the communication duration and/or cycle of the periodic TDLS service on each connection in the plurality of connections. The periodic TDLS service and its communication duration and cycle may be similar to the embodiment with reference to operation S460 in FIG. 4, and repeated descriptions are omitted here to avoid redundancy.

The communication method provided according to the embodiments of the present disclosure may coordinate the communication between EMLSR/NSTR and TDLS, avoid communication conflicts, and improve spectrum utilization.

FIG. 6 is a block diagram illustrating a communication device 600 according to an embodiment of the present disclosure.

Referring to FIG. 6, the communication device 600 may include a processing module 610 and a transceiver module 620.

In one embodiment of the present disclosure, the communication device 600 shown in FIG. 6 may be implemented as a non-AP STA MLD. In this case, the processing module 610 may be configured to listen at each of the plurality of connections before the communication device 600 conducts a tunneled direct link setup (TDLS) communication, wherein the communication of the communication device 600 can only be carried out on one connection at the same time. If the listening result indicates that the AP MLD is performing data transmission, the TDLS communication is delayed, wherein the AP MLD supports multi-link communication and the communication device 600 is associated with the AP MLD. According to an embodiment of the present disclosure, the processor 610 may be further configured to determine the duration for delaying the TDLS communication based on the duration of the data transmission perceived while listening.

According to an embodiment of the present disclosure, the transceiver module 620 may be configured to: send a first message frame to the AP MLD on a first connection among the plurality of connections, wherein the first message frame includes information indicating that the communication device 600 to requests the TDLS data transmission; and receiving a second message frame from the AP MLD, wherein the second message frame indicates that the communication device 600 is allowed to send TDLS data on the first connection.

According to an embodiment of the present disclosure, when a periodic TDLS service exists in the communication device 600, the processing module 610 may be configured to: configure the communication duration and/or cycle information of the periodic TDLS service; the transceiver module 620 may be configured to: before performing the communication of the periodic TDLS service, send information about the communication duration and/or cycle of the periodic TDLS service to the AP MLD. According to an embodiment of the present disclosure, the sent communication duration and/or cycle information about the periodic TDLS service includes the communication duration and/or cycle of the periodic TDLS service on each connection in the plurality of connections.

According to an embodiment of the present disclosure, the transceiver module 620 may be configured to: receive a third message frame from the AP MLD, where the third message frame may include duration information of TDLS communication configured by the AP MLD. For example, the configured duration information of TDLS communication includes: the duration of TDLS communication on each of the multiple connections of the AP MLD.

In the case where the communication device 600 shown in FIG. 6 is implemented as a non-AP STA MLD, the communication device 600 may perform the communication method described with reference to FIG. 3 and the operations performed by the non-AP STA MLD in FIG. 4, repeated descriptions are omitted here to avoid redundancy.

In another embodiment of the present disclosure, the communication device 600 shown in FIG. 6 may be implemented as an AP MLD. In this case, the transceiver module 620 may be configured to: receive a first message frame from the non-AP STA MLD on a first connection among the plurality of connections, wherein the first message frame includes information indicating that the non-AP STA MLD requests TDLS data transmission, the communication device 600 is associated with the non-AP STA MLD, where the communication of the non-AP STA MLD can only be carried out on one connection at the same time; the processing module 610 is configured to: in response to receiving the first message frame, control the transceiver module to send a second message frame to the non-AP STA MLD, where the second message frame indicates that the non-AP STA MLD is allowed to send TDLS data on the first connection.

The processing module 610 may be configured to: configure duration information of TDLS communication. The transceiver module 620 may also be configured to send a third message frame, where the third message frame includes duration information of the TDLS communication configured by the communication device 600 (for example, the processing module 610). For example, the configured duration information of TDLS communication includes the duration of TDLS communication on each of the multiple connections of the communication device 600.

The transceiver module 620 may also be configured to: receive information about the communication duration and/or cycle of the periodic TDLS service related to the periodic TDLS service of the non-AP STA MLD. For example, the information about the communication duration and/or cycle of the periodic TDLS service includes the communication duration and/or cycle of the periodic TDLS service on each of the multiple connections of the non-AP STA MLD.

In the case where the communication device 600 shown in FIG. 6 is implemented as an AP MLD, the communication device 600 can perform the communication method described with reference to FIG. 5 and the operations performed by the AP MLD in FIG. 4, and repeated descriptions are omitted here to avoid redundancy.

Further, the communication device 600 shown in FIG. 6 is only exemplary, and embodiments of the present disclosure are not limited thereto. For example, the communication device 600 may also include other modules, such as a memory module and the like. Furthermore, individual modules in communication device 600 may be combined into more complex modules, or may be divided into more individual modules.

Based on the same principles as the methods provided by the embodiments of the present disclosure, embodiments of the present disclosure also provide an electronic device, the electronic device includes a processor and a memory; wherein, machine-readable instructions (also, may be referred to as “computer program”) are stored in the memory; and a processor for executing machine-readable instructions to implement the methods described with reference to FIGS. 3 to 5.

Embodiments of the present disclosure also provide a computer-readable storage medium having a computer program stored on the computer-readable storage medium. When the computer program is executed by a processor, the method described with reference to FIGS. 3 to 5 is implemented.

In example embodiments, the processor may be used to implement or execute various exemplary logical blocks, modules and circuits described in connection with the present disclosure, such as a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components, or any combination thereof. The processor can also be a combination that implements computing functions, such as a combination of one or more microprocessors, a combination of a DSP and a microprocessor, etc.

In example embodiments, the memory may be, for example, a ROM (Read Only Memory), a RAM (Random Access Memory), an EEPROM (Electrically Erasable Programmable Read Only Memory), a CD-ROM (Compact Disc Read Only Memory) or other optical storage, optical disc storage (including compressed optical discs, laser discs, optical discs, digital versatile discs, Blu-ray discs, etc.), magnetic disk storage media or other magnetic storage devices, or any other medium that can be used to carry or store program codes in the form of instructions or data structures and capable of being accessed by a computer, but is not limited thereto.

It should be understood that although various steps in the flowchart of the accompanying drawings are shown in sequence as indicated by arrows, these steps are not necessarily performed in the order indicated by arrows. Unless explicitly stated in this disclosure, the execution of these steps is not strictly limited in order, and they can be executed in other orders. In addition, at least some of the steps in the flow chart of the accompanying drawings may include multiple sub-steps or multiple stages. These sub-steps or stages are not necessarily executed at the same time, but may be executed at different times, and their execution order is also not necessarily need to be performed sequentially, but may be performed in turn or alternately with other steps or at least part of the stages or sub-steps of other steps.

While the disclosure has been shown and described with reference to certain embodiments thereof, those skilled in the art will understand that various changes may be made in form and detail without departing from the scope of the disclosure. Therefore, the scope of the present disclosure should not be limited to the embodiments, but should be defined by the appended claims and their equivalents.

Obviously, numerous modifications and variations of the present disclosure are possible in light of the above teachings. It is therefore to be understood that within the scope of the appended claims, the disclosure may be practiced otherwise than as specifically described herein.

1. A multi-link communication method, wherein the communication method is executed by a station device that supports multi-link communication, and the communication method comprises:
before performing tunneled direct link setup TDLS communication by the station device, listening on each of multiple connections, wherein the station device can only perform communication on one connection at a same time; and
delaying the TDLS communication in the case that a result of the listening indicates that an access point device is performing data transmission, wherein the access point device supports multi-link communication and the station device is associated with the access point device.

2. The communication method according to claim 1, wherein a duration for delaying the TDLS communication is determined based on a duration of the data transmission sensed during the listening.

3. The communication method according to claim 1, further comprising:
sending a first message frame to the access point device on a first connection of the multiple connections, wherein the first message frame comprises information indicating that TDLS data transmission is requested by the station device; and
receiving a second message frame from the access point device, wherein the second message frame is configured to indicate that the station device is allowed to send the TDLS data on the first connection.

4. The communication method according to claim 1, further comprising:
in a case where the station device has a periodic TDLS service, sending information about communication duration and/or cycle of the periodic TDLS service to the access point device.

5. The communication method according to claim 4, wherein the sent information about communication duration and/or cycle of the periodic TDLS service comprises: the communication duration and/or cycle of the periodic TDLS service on each of the multiple connections.

6. The communication method according to claim 1, further comprising:
receiving a third message frame from the access point device, wherein the third message frame comprises duration information of the TDLS communication configured by the access point device.

7. The communication method according to claim 6, wherein the configured duration information of the TDLS communication comprises: the duration of TDLS communication on each of the multiple connections.

8. A multi-link communication method, wherein the communication method is executed by an access point device that supports multi-link communication, and the communication method comprises:
receiving a first message frame from a station device supporting multi-link communication on a first connection among multiple connections, wherein the first message frame comprises information indicating that TDLS data transmission is requested by the station device, and the access point device is associated with the station device, wherein the station device can only perform communication on one connection at a same time; and
sending a second message frame to the station device in response to receiving the first message frame, wherein the second message frame is configured to indicate that the station device is allowed to send the TDLS data on the first connection.

9. The communication method according to claim 8, further comprising:
receiving information of communication duration and/or cycle of a periodic TDLS service related to the periodic TDLS service of the station device.

10. The communication method according to claim 9, wherein the information of communication duration and/or cycle of the periodic TDLS service comprises: the communication duration and/or cycle of the periodic TDLS service on each of the multiple connections.

11. The communication method according to claim 8, further comprising:
sending a third message frame, wherein the third message frame comprises duration information of the TDLS communication configured by the access point device.

12. The communication method according to claim 11, wherein the configured duration information of the TDLS communication comprises: the duration of TDLS communication on each of the multiple connections.

13. A communication device, wherein the communication device supports multi-link communication, and the communication device comprises:
a processor: and
a memory, having a computer program stored thereon,
wherein when the computer program is executed by the processor, the execution causes the processor to:
before performing tunneled direct link setup TDLS communication by the communication device, listen on each of multiple connections, wherein the communication device can only perform communication on one connection at a same time; and
delay the TDLS communication in the case that a result of the listening indicates that an access point device is performing data transmission, wherein the access point device supports multi-link communication and the communication device is associated with the access point device.

14. The communication device according to claim 13, wherein the execution further causes the processor to determine a duration for delaying the TDLS communication based on a duration of the data transmission sensed during the listening.

15. The communication device according to claim 13, further comprising:
a transceiver, wherein the execution causes the processor to control the transceiver to:
send a first message frame to the access point device on a first connection of the multiple connections, wherein the first message frame comprises information indicating that TDLS data transmission is requested by the communication device; and
receive a second message frame from the access point device, wherein the second message frame is configured to indicate that the communication device is allowed to send the TDLS data on the first connection.

16. The communication device according to claim 13, further comprising:
a transceiver, wherein the execution causes the processor to control the transceiver to:
in a case where the communication device has a periodic TDLS service, send information about communication duration and/or cycle of the periodic TDLS service to the access point device.

17. The communication device according to claim 16, wherein the sent information about communication duration and/or cycle of the periodic TDLS service comprises: the communication duration and/or cycle of the periodic TDLS service on each of the multiple connections.

18. The communication device according to claim 13, further comprising:
a transceiver, wherein the execution causes the processor to control the transceiver to receive a third message frame from the access point device, wherein the third message frame comprises duration information of the TDLS communication configured by the access point device.

19. The communication device according to claim 18, wherein the configured duration information of the TDLS communication comprises: the duration of TDLS communication on each of the multiple connections.

20. A communication device, wherein the communication device supports multi-link communication, and the communication device comprises:
processor: and
a memory, having a computer program stored thereon,
wherein when the computer program is executed by the processor, the execution causes the processor to perform the multi-link communication method according to claim 8.

21-26. (Canceled)
